(19) United States
(12) Patent Application Publication
(10) Pub. No.: US 2007/0236962 A1
(43) Pub. Date: Oct. 11, 2007

(54) Method and Circuit Arrangement for Optimising Maximum Current Limitation in the Primary Switch of a Switched Mode Power Supply, and a Power Supply

(76) Inventor: Jarmo Minkkinen, Pertteli (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/628,593

(22) PCT Filed: Jun. 7, 2004
(86) PCT No.: PCT/FI04/00348

§ 371 Date: Dec. 4, 2006

(51) Int. Cl. H02M 3/335

(52) U.S. Cl. 363/16

(57) ABSTRACT

A power supply converts an input voltage to an output voltage. A primary cur-rent path comprises a primary coil (105, 601), a primary switch (104, T1) and a resistive path portion (109, 301, 302, 401, 402, 501, R4, T3, R15). A pulse forming circuit (108) is adapted to deliver switching pulses to the primary switch (104, T1). As a part of the pulse forming circuit there is a cut-off switch (201, T2) adapted to end a switching pulse as a response to a voltage drop over the resistive path portion (109, 301, 302, 401, 402, 501, R4, T3, R15) reaching a threshold value. An electrically controllable resistance (301, 302, 401, 402, 501, T3, R15) constitutes a part of the resistive path portion and is responsive by its resistance value to a value of an input voltage coupled to the power supply.

### CROSS REFERENCE TO RELATED APPLICATIONS

This application is for entry into the U.S. national phase under §371 for International Application No. PCT/FI04/000348 having an international filing date of Jun. 7, 2004, and from which priority is claimed under all applicable sections of Title 35 of the United States Code including, but not limited to, Sections 120, 363 and 365(c)

### TECHNICAL FIELD

The invention concerns generally the circuit topology of switched-mode power supplies. Especially the invention concerns a circuit arrangement that is used to limit the maximum current that may flow through the primary switch, which is the switching component that chops the current that flows through the primary coil of the transformer in the switched-mode power supply.

### BACKGROUND OF THE INVENTION

FIG. 1 is a schematic illustration of certain known features that are usually found on the primary side of a switched-mode power supply. In FIG. 1, a switched-mode power supply 100 comprises a primary side 101 and a secondary side 102 separated from each other by a transformer 103. A switch 104 on the primary side repeatedly switches the current flowing through a primary coil 105, which causes energy to be stored into the magnetic field of the transformer 103. A diode 106 on the secondary side only allows current to flow in one direction through a secondary coil 107. The switching pulses for the primary switch 104 come from a pulse forming circuit 108, which may receive some kind of control information that describes the momentary need of energy that should be conveyed over the transformer 103 from the primary side 101 to the secondary side.

FIG. 1 illustrates specifically one control mechanism that is affecting the way in which pulses are formed in the pulse forming circuit 108. Coupled in series with the switch 104 there is a current sensing resistor 109. When at the beginning of a switching pulse the switch 104 is closed, a primary current starts to flow through the series coupling of the primary coil 105, switch 104 and current sensing resistor 109. The larger the primary current value, the larger a voltage drop can be observed over the current sensing resistor 109. The pulse forming circuit 108 comprises a trigger mechanism (not separately shown in FIG. 1) that is adapted to react when said voltage drop exceeds a threshold value, by terminating the ongoing switching pulse. This functionality is known as maximum primary current limiting, or maximum current limitation in the primary switch. An exemplary prior art publication utilising such a circuit arrangement is DE 101 43 016 A1.

A common objective of the designers of switched-mode power supplies, as well as devices such as battery chargers that are essentially built around a switched-mode power supply, is to make the device accept a wide range of input voltages. A simple consequence of Ohm's law is that with lower input voltages there must be higher currents to deliver a constant amount of electric energy, compared to higher input voltages. A problem arises, how should one take into account the fact that the maximum primary current limiting functionality as such always reacts to the same threshold value of the primary current.

A known solution is to select the value of the current sensing resistor 109 small enough so that the maximum primary current limiting functionality actually only functions perfectly with low input voltages, and to accept the fact that with higher input voltages it would allow excessively large amounts of energy to rush through the primary side circuitry. Such an approach needs to be complemented with e.g. a secondary side control arrangement, which monitors the amount of transferred energy and with higher input voltages is quicker to provide limiting actions than the maximum primary current limiting functionality. A drawback is then that the secondary side control arrangement will be inevitably somewhat slow to react, which means that a high primary current peak may pass through before the limiting actions step in. A high current peak through an inductive component emits large amounts of electromagnetic interference, which may be observed even as audible noise.

A prior art solution to said problem is known from the publication U.S. Pat. No. 6,608,769, in which there is a direct coupling from the input voltage to the pulse forming circuit. The principle of this solution is generally shown in FIG. 2 on a very allusive level. On the primary side 101 of a switched-mode power supply there are a primary switch 104, a primary coil 105, a pulse forming circuit 108 and a current sensing resistor 109. As a part of the pulse forming circuit (which obviously must include also other parts, which however are not shown in FIG. 2 for the reasons of graphical clarity) there is a so-called cut-off switch 201, the task of which is to terminate each switching pulse by coupling the gate electrode of the primary switch 104 to ground. The moment at which such coupling occurs depends on the potential of a point 202, from which there is a coupling to the gate or base electrode of the cut-off switch 201. The arrow 203 represents the traditional effect of maximum primary current limiting, according to which an increasing voltage drop over the current sensing resistor 109 raises the potential of point 202 until it eventually suffices to turn on the cut-off switch 201. The additional idea presented in U.S. Pat. No. 6,608,769 is to have a coupling 204 from the input voltage to point 202, so that a higher input voltage preparatorily draws higher the potential of point 202 and thus sensitises the maximum primary current limiting functionality.

Even if the solution of U.S. Pat. No. 6,608,769 manages to introduce certain input voltage dependency to the maximum primary current limiting functionality, it may still allow excessively high primary current peaks e.g. during so-called interrupted operation or chopped mode, which may be a built-in property of the switched-mode power supply or may also occur when there is an “intelligent” load such as an electronically controlled battery to be loaded. In the latter case, when the battery is almost full, its internal controlling circuit begins to chop the charging current, which the switched-mode power supply in the charger sees as if a load was regularly coupled and uncoupled at the output. At the moment of coupling the load, all charge that was stored in e.g. snubber capacitances will instantly discharge, which causes a primary current peak. Similar consequences arises if the chopped mode is implemented in control circuitry internal to the switched-mode power supply.

### SUMMARY OF THE INVENTION

An objective of the present invention is to present a method and a circuit arrangement for implementing maximum primary current limiting in a way that adapts well to wide variations in input voltage and is also effective against current peaks associated with transient phenomena such as instantaneous coupling of a load. An additional objective of the invention is to achieve said result without unnecessarily complicating the circuit topology of the switched-mode power supply.

The objectives of the invention are achieved by arranging alternative detection mechanisms for primary current detecting, and switching them into use depending on the input voltage.

The circuit arrangement according to the invention is characterised by the features recited in the characterising part of the independent claim directed to a circuit arrangement.

The invention is also directed to a power supply, the characteristic features of which are recited in the characterising part of the independent claim directed to a power supply.

Additionally the invention is directed to a method for controlling a switched-mode power supply, the characteristic features of which are recited in the characterising part of the independent claim directed to a method.

The optimal resistance value of the current sensing resistor is proportional to the absolute value of the input voltage: for a large input voltage, a relatively large resistance value should be used, while for lower input voltages also the resistance of the current sensing resistor should be lower. According to the present invention, the effective sensing resistance value that exists on the path of the primary current is altered according to the input voltage. In a simple embodiment there is a basic resistance dimensioned for optimal operation at or close to one extremity of the allowable input voltage range, and a switch that reacts to input voltage approaching the other extremity by coupling another current path into use or out of use, so that the combined resistance of the other current path and the basic resistance becomes optimal towards said other extremity of the allowable input voltage range.

If the transformer of the switched-mode power supply comprises a so-called additional coil, it is advantageous to derive from the voltage waveform of the additional coil an indicator signal indicative of the input voltage value. This indicator signal can then be used to drive at least one switch, which couples additional resistive primary current paths into use according to need.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

The exemplary embodiments of the invention presented in this patent application are not to be interpreted to pose limitations to the applicability of the appended claims. The verb “to comprise” is used in this patent application as an open limitation that does not exclude the existence of also unrecited features. The features recited in depending claims are mutually freely combinable unless otherwise explicitly stated.

### BRIEF DESCRIPTION OF THE DRAWINGS

The invention itself, however, both as to its construction and its method of operation, together with additional objects and advantages thereof, will be best understood from the following description of specific embodiments when read in connection with the accompanying drawings.

FIG. 1 illustrates a prior art switched-mode power supply,

FIG. 2 illustrates a known arrangement for introducing input voltage dependency,

FIG. 3 illustrates a principle according to an embodiment of the invention,

FIG. 4 illustrates a principle according to another embodiment of the invention,

FIG. 5 illustrates a principle according to yet another embodiment of the invention,

FIG. 6 illustrates a circuit where a principle according to an embodiment of the invention is applied, and

FIG. 7 illustrates an embodiment of the invention in method form.

### DETAILED DESCRIPTION

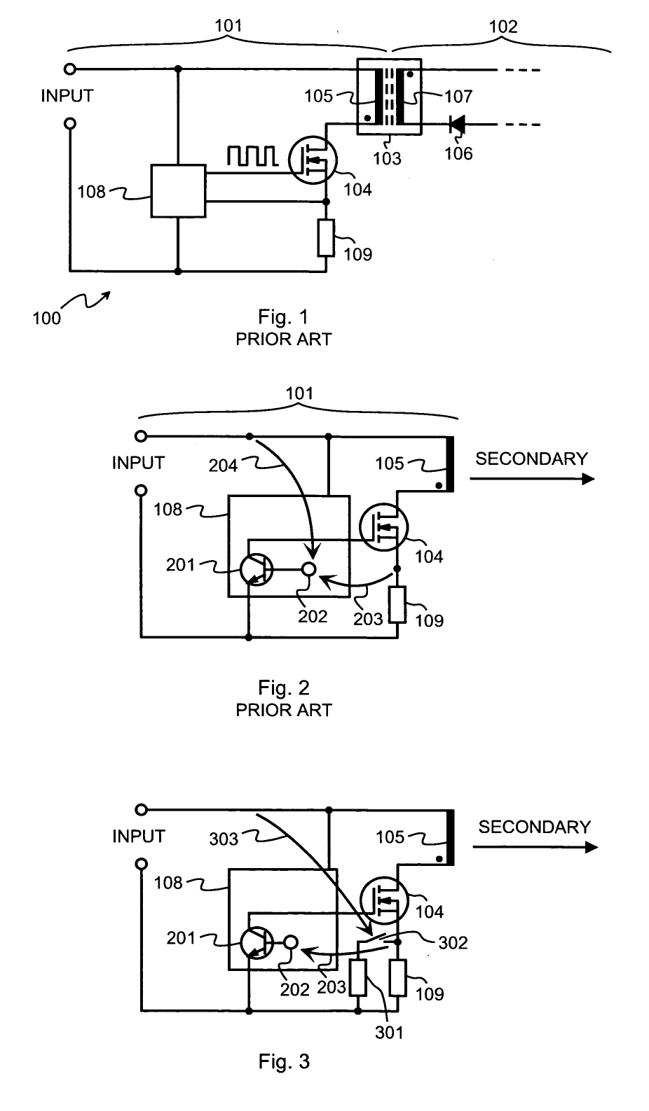

FIG. 3 illustrates an embodiment of the invention on a very allusive, high and abstract level that resembles the approach of graphical representation in FIG. 2. On the primary side of a switched-mode power supply there are a primary switch 104, a primary coil 105, a pulse forming circuit 108 and a current sensing resistor 109. Similarly to FIG. 2, as a part of the pulse forming circuit (which also here obviously must include also other parts, which however are not shown in FIG. 3 for the reasons of graphical clarity) there is the cut-off switch 201. Arrow 203 again represents the effect of maximum primary current limiting, according to which an increasing voltage drop over the current sensing resistor raises the potential of point 202 until it eventually suffices to turn on the cut-off switch 201. However, in parallel with the traditional current sensing resistor 109 there is the series connection of another resistor 301 and a switch 302. A control signal for driving the switch 302 is taken directly or derived indirectly from the input voltage, as is represented schematically by arrow 303.

Since the combined resistance of two parallelly connected resistors is always smaller than the resistance of any of said resistors alone, the coupling principle of FIG. 3 indicates that for higher input voltages the switch 302 should remain open so that only resistor 109 is used for maximum primary current limiting. For optimal performance at lower input voltages the resistance of resistor 109 is too high, so as a response to a lower input voltage the switch 302 is closed to take the lower combined resistance of resistors 109 and 301 into use for maximum primary current limiting.

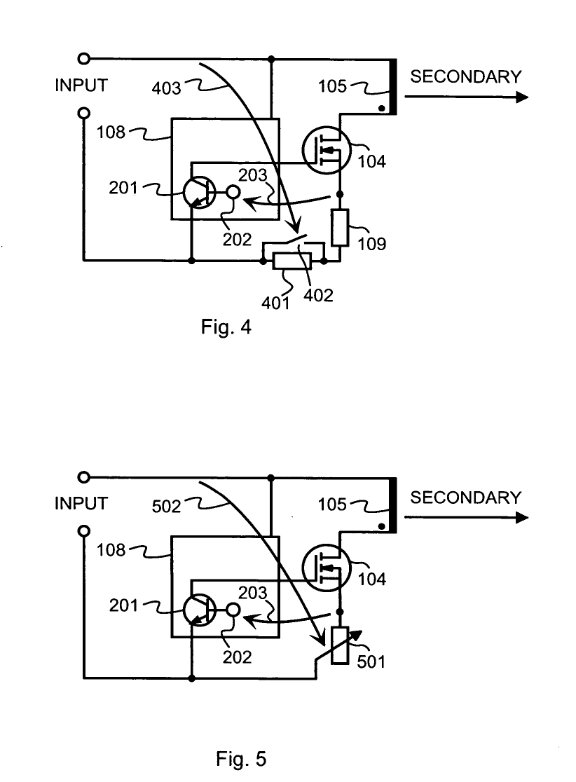

FIG. 4 illustrates an alternative embodiment to that in FIG. 3. In the circuit arrangement of FIG. 4 the resistance used for primary current sensing is a series connection of the traditional current sensing resistor 109 and another resistor 401, which latter is additionally connected in parallel with a shunting switch 402. A control signal for driving the switch 402 is taken directly or derived indirectly from the input voltage, as is represented schematically by arrow 403.

Since the combined resistance of two serially connected resistors is always larger than the resistance of any of said resistors alone, the coupling principle of FIG. 4 indicates that for higher input voltages the switch 402 should remain open so that the combined resistance of resistors 109 and 401 is used for maximum primary current limiting. For optimal performance at lower input voltages said combined resistance is too high, so as a response to a lower input voltage the switch 302 is closed to short-circuit resistor 401, leaving only the resistance of the traditional current sensing resistor 109 into use for maximum primary current limiting.

FIG. 5 illustrates a yet alternative principle in which the current sensing resistor is a voltage controlled resistor 501. A control signal for controlling its resistance is taken directly or derived indirectly from the input voltage, as is represented schematically by arrow 502. The control relationship must be of a directly proportional type, i.e. an increasing input voltage must cause the resistance of the voltage controlled resistor 501 to increase and vice versa.

In selecting between the principles illustrated schematically in FIGS. 3, 4, and 5 one should note that an inherently large current sensing resistance is usually safest for maximum primary current limiting, because it causes a sharper increase in the voltage drop across the current sensing resistor and is thus likely to trigger limiting action earlier than if the current sensing resistance was small. Additionally it helps to attenuate the current peaks caused by transient effects, which were discussed in the description of prior art. Depending on the implementation of a controllable switch, in the absence of any control signal the switch is either inherently open or inherently closed. Both embodiments of FIGS. 3 and 4 are such that if the controllable switch is inherently open, the resistance used for current sensing is inherently large.

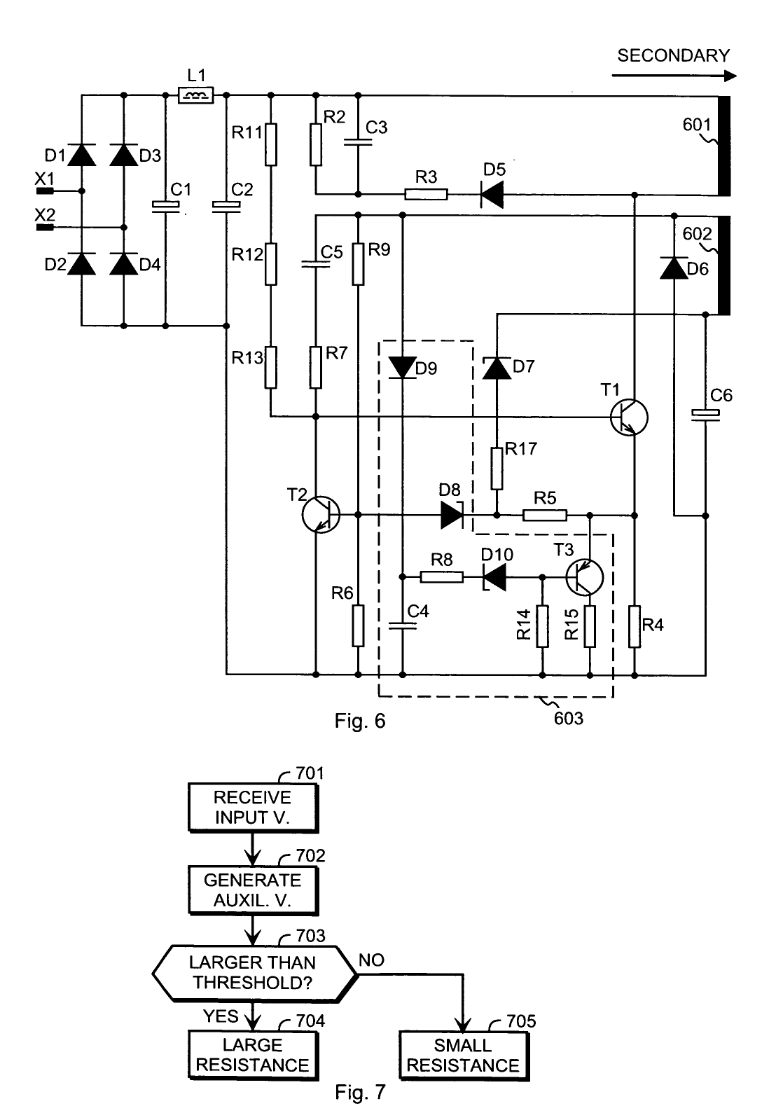

FIG. 6 illustrates an embodiment of the invention on a more practical level. The circuit diagram of FIG. 6 describes the primary side of a switched-mode power supply, the transformer of which comprises a primary coil 601, a secondary coil which is not illustrated in FIG. 6, and an auxiliary coil 602 coupled to the primary side. The secondary side of the switched-mode power supply would be located to the right of the circuit diagram of FIG. 6, but since its implementation is irrelevant to the following description of how the invention is applied, it is not described in any more detail.

Terminals X1 and X2 are adapted to receive an AC input voltage. Diodes D1, D2, D3 and D4, capacitors C1 and C2 as well as the choke L1 constitute a well-known rectifier and input filter coupling. The conventional primary current route is coupled across the output of said rectifier and input filter coupling, and consists of the primary coil 601, the primary switch T1 and the current sensing resistor R4. Resistors R2 and R3 as well as capacitor C3 and diode D5 constitute a well-known ringing attenuator for the primary coil.

Diode D6, capacitor C6 and resistors R6 and R9 constitute a known auxiliary voltage generation circuit. The basic switching action in the circuit of FIG. 6 follows the pattern known from prior art: a switching pulse begins when the voltage coming through resistors R11, R12 and R13 reaches the gate or base electrode of the primary switch T1, and ends when the cut-off switch T2 turns on and empties the charge from said gate or base electrode of the primary switch T1 to ground. The voltage that turns on the cut-off switch T2 is essentially the voltage drop across the current sensing resistor R4, with the additional voltage limiter effect that will be caused if the auxiliary voltage grows larger than a threshold defined by the zener diode D7.

Components that would not be present in a conventional primary side of a switched-mode power supply are diodes D8, D9 and D10, resistors R8, R14 and R15, capacitor C4 and transistor T3, which in FIG. 6 are specifically emphasized as belonging to part 603 of the circuit. The anode of diode D9 is coupled to the undotted terminal of the auxiliary coil 602, and its cathode is coupled through capacitor C4 to ground. From the point between the cathode of diode D9 and capacitor C4 there is a series coupling of resistor R8 and zener diode D10 to the base of the PNP transistor T3, in which coupling the anode of the zener diode D10 is towards the base of the transistor T3. The emitter of said transistor T3 is coupled to the emitter of the primary switch T1, and the collector of said transistor T3 is coupled through resistor R15 to ground. Resistor R14 is coupled between the base of transistor T3 and ground. Zener diode D8 is placed to the otherwise conventional maximum primary current limitation arrangement so that its anode is coupled to the base of the cut-off switch T2.

Together the components of part 603 of the circuit implement in practice a functional principle essentially similar to that of FIG. 3. Diode D9 and capacitor C4 serve to produce a rectified sample of the auxiliary voltage across capacitor C4. If the input voltage to the switched-mode power supply is high, also the absolute value of the voltage across capacitor C4 will be large, exceeding the reverse direction threshold voltage of the zener diode D10, so the switching transistor T3 remains in non-conductive state and there will not be any parallel path for the primary current flowing through resistor R4. With small input voltages to the switched-mode power supply, only a relatively small voltage will accumulate across capacitor C4. The zener diode D10 will block it from reaching the base of transistor T3, which is therefore in conductive state. Now the primary current sees a parallel coupling of resistors R4 and R15 between the emitter of the primary switch T1 and ground. This parallel coupling of resistors R4 and R15 has a resistance that is smaller than the resistance of R4 alone, so the maximum primary current limiting functionality will allow the primary current grow larger before triggering the cut-off switch T2 to end the switching pulse. The role of the zener diode D8 is to define an additional threshold for turning on the cut-off switch T2.

FIG. 7 illustrates the principle of the invention in method form. Based on an input voltage received in the switched-mode power supply according to step 701, an auxiliary voltage is generated at step 702. Here we again assume that the absolute value of the auxiliary voltage is proportional to the input voltage value. Step 703 is a comparison, whether the absolute auxiliary voltage value is larger than a threshold (indicating a large input voltage) or smaller than a threshold (indicating a small input voltage value). A positive finding at step 703 leads to selecting a large resistance according to step 704, whereas a negative finding at step 703 leads to selecting a small resistance according to step 705.

Basically there exist even more alternative ways of implementing in practice the control principle explained above. At least in principle it is possible to construct a linear control arrangement, in which the value of an accumulated auxilary voltage (cf. the voltage across capacitor C4 in FIG. 6) linearly affects the voltage comparison that eventually results in terminating a switching pulse with a cut-off switch. However, compared to the threshold-driven approach illustrated above such linear control arrangements may easily lead to problems with efficiency and reliability.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A circuit arrangement for limiting a maximum primary current of a switched-mode power supply, comprising:
a resistive path (109, 301, 302, 401, 402, 501, R4, T3, R15) adapted to carry a primary current and
a cut-off switch (201, T2) adapted to end a switching pulse in said switched-mode power supply as a response to a voltage drop over said resistive path (109, 301, 302, 401, 402, 501, R4, T3, R15) reaching a threshold value, wherein the resistance of said resistive path (109, 301, 302,401,402, 501, R4, T3, R15) is electrically controllable.

2. The circuit arrangement according to claim 1, wherein said resistive path comprises a first resistor (109, R4), and coupled in parallel with said first resistor (109, R4) a series connection of a second resistor (301, R15) and an electrically controllable switch (302, T3).

3. The circuit arrangement according to claim 1, wherein said resistive path comprises a first resistor (109), and coupled in series with said first resistor (109) a parallel connection of a second resistor (401) and an electrically controllable switch (402).

4. The circuit arrangement according to claim 1, wherein said resistive path comprises a voltage-controlled resistor (501).

5. A power supply for converting an input voltage to an output voltage, comprising:
a primary current path comprising a primary coil (105, 601), a primary switch (104, T1) and a resistive path portion (109, 301, 302, 401, 402, 501, R4, T3, R15),
a pulse forming circuit (108) adapted to deliver switching pulses to said primary switch (104, T1),
as a part of the pulse forming circuit a cut-off switch (201, T2) adapted to end a switching pulse as a response to a voltage drop over said resistive path portion (109, 301, 302, 401, 402, 501, R4, T3, R15) reaching a threshold value; and
an electrically controllable resistance (301, 302, 401, 402, 501, T3, R15) as a part of said resistive path portion, which electrically controllable resistance (301, 302, 401, 402, 501, T3, R15) is responsive by its resistance value to a value of an input voltage coupled to the power supply.

6. The power supply according to claim 5, wherein it comprises:
an auxiliary voltage generation circuit (602, C6, D6), and
an electrically controllable switch (302, 402, T3) constituting a part of the resistive path portion (301, 302, 401, 402, 501, T3, R15) and coupled to receive an auxiliary voltage generated by said auxiliary voltage generation circuit (602, C6, D6);
wherein said electrically controllable switch (302, 402, T3) is adapted to turn into a non-conductive state as a response to said auxiliary voltage reaching a threshold value and into a conductive state as a response to said auxiliary voltage not reaching said threshold value.

7. The power supply according to claim 6, wherein said resistive path portion comprises a first resistor (109, R4), and coupled in parallel with said first resistor (109, R4) a series connection of a second resistor (301, R15) and said electrically controllable switch (302, T3).

8. The power supply according to claim 6, wherein said resistive path portion comprises a first resistor (109), and coupled in series with said first resistor (109) a parallel connection of a second resistor (401) and said electrically controllable switch (402).

9. A method for limiting a maximum primary current of a switched-mode power supply, comprising:
monitoring a voltage drop caused by a primary current flowing through a resistive path portion,
as a response to said voltage drop reaching a threshold value, cutting off a switching pulse delivered to a primary switch of said switched-mode power supply,
monitoring (701) an input voltage coupled to said switched-mode power supply, and
as a response to a change (703) in said input voltage, changing (704, 705) the resistance of said resistive path portion.

10. The method according to claim 9, wherein it comprises generating (702) an auxiliary voltage representative of said input voltage and using said auxiliary voltage to drive an electrically controllable switch that constitutes a part of said resistive path portion, the resistance of said resistive path portion depending on the state of conduction of said electrically controllable switch.
